(19) United States
(12) Patent Application Publication
(10) Pub. No.: US 2016/0369748 A1
(43) Pub. Date: Dec. 22, 2016

(54) OIL RETAINING AMOUNT DETERMINATION DEVICE

(71) Applicants: AISAN KOGYO KABUSHIKI KAISHA, Obu-shi (JP); TOYOTA JIDOSHA KABUSHIKI KAISHA, Toyota-shi (JP)

(72) Inventors: Shoichiro Takekawa, Nagoya-shi (JP); Nao MURASE, Nagoya-shi (JP)

(73) Assignees: AISAN KOGYO KABUSHIKI KAISHA, Obu-shi (JP); TOYOTA JIDOSHA KABUSHIKI KAISHA, Toyota-shi (JP)

(21) Appl. No.: 15/182,740

(22) Filed: Jun. 15, 2016

(30) Foreign Application Priority Data
Jun. 19, 2015 (JP) 2015-123760

(51) Int. Cl. F02M 21/02; F02D 41/00; F02D 41/06; F02B 43/10

(52) U.S. Cl. CPC F02M 21/0227; F02B 43/10; F02M 21/0215; F02D 41/0027; F02D 41/062; F02B 2043/103

(57) ABSTRACT

An oil retaining amount determination device includes a collected-liquid tank, an element, a thermistor, and a control unit. The collected-liquid tank is arranged in a supply line of CNG. The element separates oil from the CNG that flows into the collected-liquid tank. The thermistor is arranged in a downward direction from the element in the collected-liquid tank and generates heat by being electrified. The control unit determines whether the thermistor is immersed in the oil based on change of a thermistor voltage at the time of electrification of the thermistor. The control unit performs the determination procedure when flow of the CNG in the supply line is stopped.

### BACKGROUND OF THE INVENTION

The present invention relates to an oil retaining amount determination device.

Japanese Laid-Open Patent Publication No. 2014-105602 discloses an internal combustion engine driven by gas fuel such as CNG (Compressed Natural Gas). The engine has a supply system for the gas fuel. The supply system has a supply line for supplying the gas fuel to an injection valve and an oil separator for separating foreign matter such as oil from the gas fuel flowing in the supply line.

The oil separator includes a collected-liquid tank for retaining the foreign matter, such as the oil, and a separating portion arranged in the collected-liquid tank. The separating portion separates the undesired matter, such as the oil, from the gas fuel that flows into the collected-liquid tank. A thermistor is arranged in a downward direction from the separating portion in the oil separator. Based on the changing manner of the temperature detected by the thermistor, it is determined whether the oil retaining amount of the collected-liquid tank is greater than or equal to a specific amount.

A pressure reducing valve, which reduces the pressure of the high-pressure gas fuel supplied from a fuel tank to a specific pressure, is arranged in the supply line of the gas fuel. The temperature of the oil retained in the collected-liquid tank is substantially equal to the ambient temperature at the position where the collected-liquid tank is installed. In contrast, after the gas fuel is supplied from the fuel tank, the pressure of the gas fuel is reduced by the pressure reducing valve. The temperature of the gas fuel is thus low when the gas flows into the collected-liquid tank. In this circumstance, in which the low-temperature gas fuel flows into the collected-liquid tank, the thermistor may not be immersed in the oil. In this case, the thermistor is exposed to the low-temperature gas fuel. As a result, the temperature detected by the thermistor tends to change frequently.

In contrast, the temperature of the oil does not change frequently. Therefore, even in the circumstance in which the low-temperature gas fuel flows into the collected-liquid tank, the temperature of the thermistor does not change frequently when the thermistor is immersed in the oil, compared to when the thermistor is not immersed in the oil.

As described in the aforementioned patent document, a smoothing procedure is performed on the temperature detected by the thermistor if the flow speed of the gas fuel in the supply line is relatively high. That is, a first smoothed temperature and a second smoothed temperature, which exhibit different delays in their variation with respect to variation of the thermistor temperature, are obtained for every control cycle. The second smoothed temperature is a value that varies with a great delay compared to the first smoothed temperature. Subsequently, a correction value is calculated by subtracting a predetermined offset value from the second smoothed temperature. When the first smoothed temperature is smaller than the correction value, a temperature integration value is obtained by integrating differences between the correction value and the first smoothed temperature. Such integration of the differences is performed by a specific number of times and, eventually, it is determined whether the thermistor is immersed in the oil depending on whether the temperature integration value is smaller than or equal to a threshold value.

The aforementioned specific number of times and threshold value are determined based on various data obtained by operating a vehicle employing the internal combustion engine in various modes.

The flow amount of the gas fuel flowing into the collected-liquid tank changes in correspondence with the amount of the gas fuel consumed by the engine. Therefore, if the above-described supply system of the gas fuel is employed in a plurality of vehicles having different displacements, the changing manner of the temperature detected by the thermistor varies from one vehicle to another. That is, to employ the above-described determination method, the aforementioned specific number of times and threshold value must be determined for each one of the vehicles, which have different displacements. This increases the number of the steps that must be carried out to adapt the above-described supply system of gas fuel for use in the vehicles having different displacements.

### SUMMARY OF THE INVENTION

Accordingly, it is an objective of the present invention to provide an oil retaining amount determination device capable of facilitating determination whether an oil retaining amount of a tank is greater than or equal to a specific amount.

To solve the above-described problem, according to a first aspect of the present invention, an oil retaining amount determination device includes a resistor located in a downward direction from a separating portion in a tank, the resistor generating heat by being electrified, and a control unit for electrifying the resistor, the control unit performing a determination procedure to determine whether the resistor is immersed in oil based on change of a characteristic caused in correspondence with change of a resistance value of the resistor when the resistor is electrified. The control unit performs the determination procedure when flow of the gas fuel in the supply line is stopped.

### BRIEF DESCRIPTION OF THE DRAWINGS

FIG. 1 is a block diagram representing the schematic configuration of an internal combustion engine including an oil retaining amount determination device according to an embodiment of the present invention.

FIG. 2 is a cross-sectional view showing a regulator arranged in a supply line of gas fuel.

FIG. 3 is a block diagram representing an electric circuit of a detection unit, which is a component of the oil retaining amount determination device.

FIG. 4 is a timing chart representing variation of voltage after electrification of a thermistor is started.

FIG. 5 is a flowchart representing a procedure routine executed to determine whether the oil retaining amount is greater than or equal to a specific amount.

FIG. 6 is a flowchart representing a part of a procedure routine of another example executed to determine whether the oil retaining amount is greater than or equal to the specific amount.

### DETAILED DESCRIPTION OF THE PREFERRED EMBODIMENTS

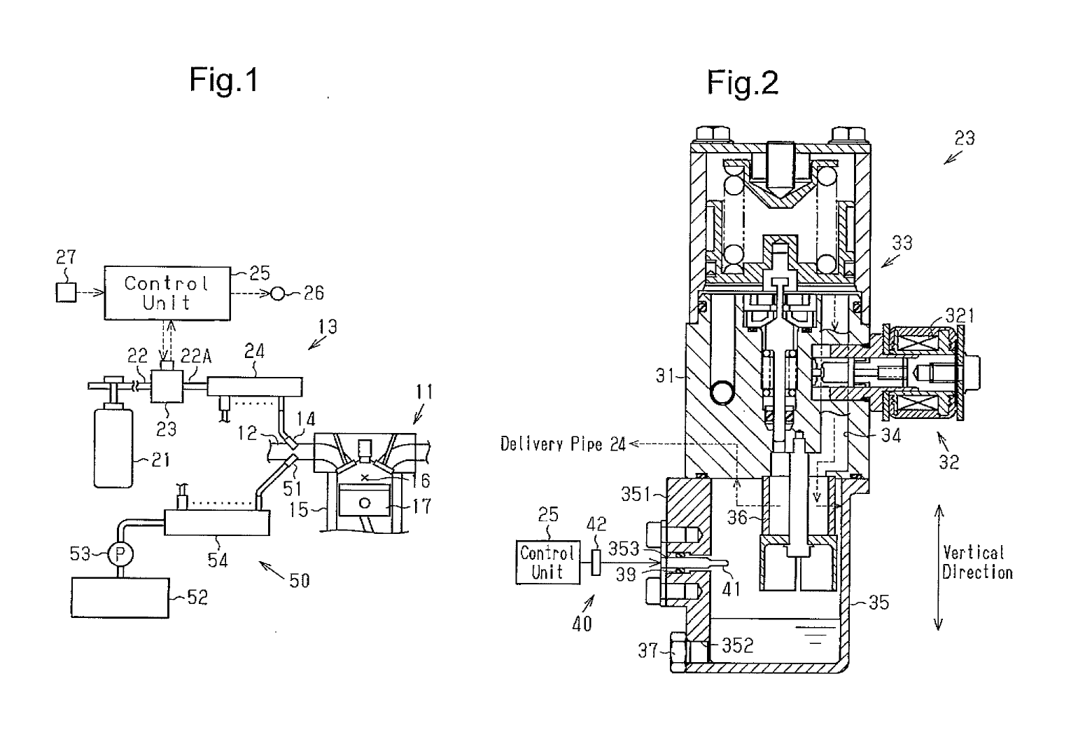

An embodiment of an oil retaining amount determination device according to the present invention will now be described with reference to FIGS. 1 to 5.

FIG. 1 illustrates a multi-fuel type internal combustion engine 11, which is capable of using CNG (Compressed Natural Gas) as an example of gas fuel and gasoline as an example of another fuel different from the gas fuel selectively.

With reference to FIG. 1, the engine 11 includes an intake passage 12 and injectors 14, 51, which are arranged in the intake passage 12. The injector 14 injects the CNG supplied from a gas fuel supply unit 13. The injector 51 injects gasoline supplied from a gasoline supply unit 50. In a combustion chamber 16 of a cylinder 15, air-fuel mixture containing the fuel, such as the CNG or the gasoline, and intake air is burned. This causes reciprocation of a piston 17, thus rotating a crankshaft, which is the output shaft of the engine 11, in a predetermined direction.

A high-pressure fuel pipe 22 is arranged in the gas fuel supply unit 13. The high-pressure fuel pipe 22 is connected to a CNG tank 21, which retains CNG. The pressure of the CNG flowing in the high-pressure fuel pipe 22 is regulated to a specific pressure by a regulator 23 including an oil separator. After the pressure of the CNG is regulated, the CNG is supplied to a delivery pipe 24. The CNG is then supplied from the delivery pipe 24 to the injector 14 and then injected by the injector 14 into the intake passage 12. The high-pressure fuel pipe 22, a pipe 22A, which connects the regulator 23 and the deliver pipe 24 to each other, and the delivery pipe 24 configure a supply line of the gas fuel.

A fuel pump 53 for drawing gasoline from a gasoline tank 52 and a delivery pipe 54, through which the gasoline pumped out from the gasoline pump 53 flows under pressure, are arranged in the gasoline supply unit 50. After having been supplied from the delivery pipe 54 to the injector 51, the gasoline is injected by the injector 51 into the intake passage 12.

To start the engine 11, gasoline is used as fuel. If a switch 27 is manipulated in operation using gasoline, the fuel supplied to the engine 11 is switched from gasoline to CNG when a predetermined condition is satisfied. Therefore, before manipulation of the switch 27, the CNG does not flow in the supply line of the gas fuel supply unit 13. After the manipulation of the switch 27, the CNG may flow in the supply line of the gas fuel supply unit 13. The switch 27 is electrically connected to a control unit 25.

The control unit 25 has a microcomputer configured by a CPU, a ROM, and a RAM. The control unit 25 performs various types of controls such as fuel injection control depending on circumstances. The regulator 23 has a collected-liquid tank 35 in which oil is retained. The control unit 25 monitors the oil retaining amount of the collected-liquid tank 35. When it is determined that the oil retaining amount exceeds a specific amount, the control unit 25 turns on an alarm lamp 26. This informs an occupant (occupants) of the vehicle of the fact that the oil retaining amount exceeds the specific amount.

The configuration of the regulator 23 will hereafter be described with reference to FIG. 2.

As shown in FIG. 2, the regulator 23 includes a body 31 and an electromagnetic type cutoff valve 32, a pressure reducing valve 33, and the collected-liquid tank 35, which are connected to the body 31. A passage 34 is formed in the body 31. The collected-liquid tank 35 is formed in a lidded cylindrical shape. The CNG flows from a CNG tank 21 into the electromagnetic type cutoff valve 32. If electric power is supplied to an electromagnetic coil 321 in response to a command from the control unit 25, the electromagnetic type cutoff valve 32 permits supply of CNG to the delivery pipe 24. In this case, the CNG flows into the body 31 after having passed through the electromagnetic type cutoff valve 32. In contrast, if the electric power is not supplied to the electromagnetic coil 321, the electromagnetic type cutoff valve 32 prohibits the supply of CNG to the delivery pipe 24.

After the CNG flows into the body 31 via the electromagnetic type cutoff valve 32, the pressure of the CNG is reduced to a specific pressure (for example, “1 MPa”) by the pressure reducing valve 33. After such pressure reduction of the CNG by the pressure reducing valve 33, the CNG flows into the collected-liquid tank 35 through the passage 34.

The collected-liquid tank 35 is attached to the lower end of the body 31 to close the opening of the collected-liquid tank 35. An annular element 36 is arranged in an upper section of the collected-liquid tank 35. The element 36 is located inside the collected-liquid tank 35. The element 36 is a separating portion for separating oil from the CNG that flows into the collected-liquid tank 35 via the passage 34. The element 36 is formed using non-woven fabric or the like and permits passage of gas such as CNG but prohibits passage of liquid such as oil. After passing through the element 36, the CNG is introduced into the delivery pipe 24 via a non-illustrated supply path formed in the body 31. After having been separated from the CNG by the element 36, the oil flows downward from the element 36 and is retained in the collected-liquid tank 35. The collected-liquid tank 35 and the element 36 configure an oil separator.

An opening section 352, which ensures communication between the interior and the exterior of the collected-liquid tank 35, is formed in the vicinity of the lower end of a side wall 351 of the collected-liquid tank 35. The opening section 352 is closed by a manually operated valve 37. When the valve 37 is detached from the collected-liquid tank 35 to open the opening section 352, the oil is discharged from the collected-liquid tank 35 to the exterior via the opening section 352.

A detection unit 40 for detecting the oil retaining amount of the collected-liquid tank 35 is arranged in the gas fuel supply unit 13. The detection unit 40 has a thermistor 41 and an electric circuit 42 for electrifying the thermistor 41. The thermistor 41 is a resistor that generates heat by being electrified. A communication hole 353, which ensures communication between the interior and the exterior of the collected-liquid tank 35, is formed in the side wall 351 of the collected-liquid tank 35. The communication hole 353 is located in a downward direction from the element 36. The thermistor 41 is inserted in the communication hole 353. The distal end of the thermistor 41 is located inside the collected-liquid tank 35. An O ring 39, which has an airproof effect and a heat insulating effect, is located between the outer peripheral surface of the thermistor 41 and the wall surface of the communication hole 353. The thermistor 41 is an NTC thermistor (a Negative Temperature Coefficient Thermistor), which exhibits a smaller resistance value at a higher temperature as the thermistor 41 is electrified.

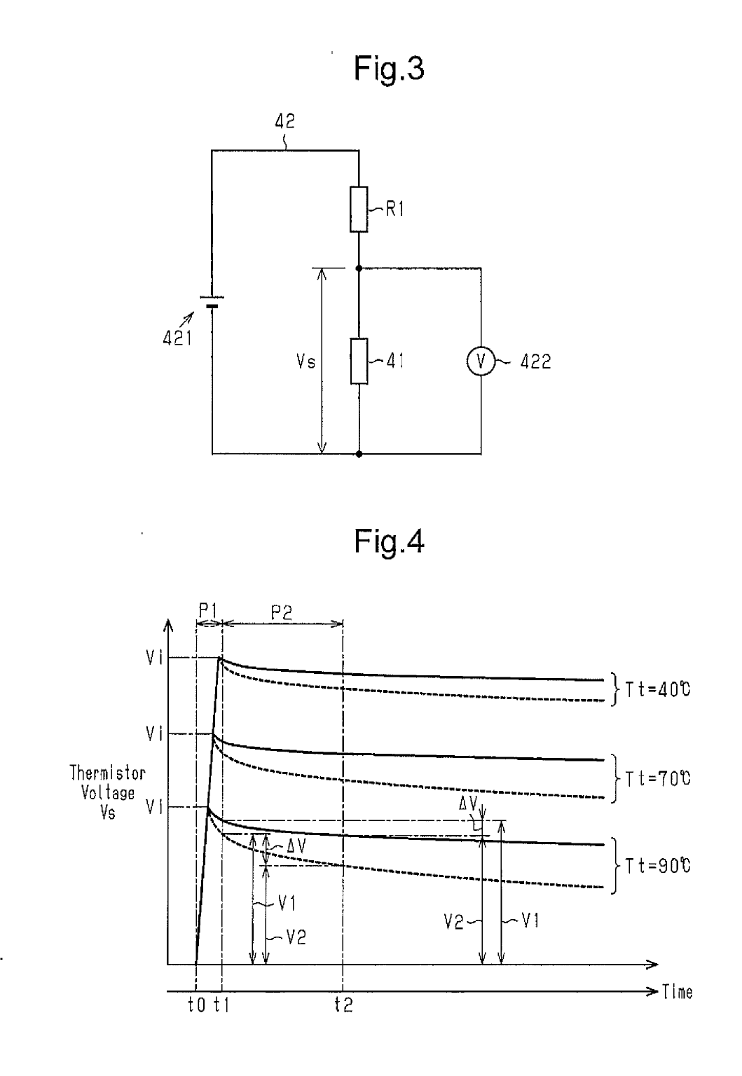

As illustrated in FIG. 3, an electric circuit 42 includes a DC power source 421. A resistor R1 and a voltmeter 422 are arranged in a line for supplying electric power to the thermistor 41. The resistor R1 is connected in series with the thermistor 41. The voltmeter 422 detects a thermistor voltage Vs, which is the voltage applied to the thermistor 41. The thermistor voltage Vs is a value indicating a characteristic caused in correspondence with change of the resistance value of the thermistor 41 and corresponds to a resistance voltage. A switching element is arranged in the electric circuit 42. The switching element is turned on to electrify the thermistor 41 and turned off to stop electrifying the thermistor 41. The resistor R1 restricts flow of a great electric current to the thermistor 41.

The oil retaining amount determination device of the present embodiment is configured by the regulator 23, the control unit 25, and the detection unit 40. When the condition that the thermistor 41 is immersed in the oil in the collected-liquid tank 35 is satisfied, the oil retaining amount determination device determines that the oil retaining amount of the collected-liquid tank 35 is greater than or equal to the specific amount.

With reference to FIG. 4, change of the thermistor voltage Vs as the time elapses in a case in which electrification of the thermistor 41 is started in a normal state in which the temperature of the thermistor 41 and the temperatures of the oil and the CNG in the collected-liquid tank 35 are all equal. In FIG. 4, change of the thermistor voltage Vs as the time elapses when the thermistor 41 is not immersed in the oil is represented by the solid lines and curves. Change of the thermistor voltage Vs as the time elapses when the thermistor 41 is immersed in the oil is represented by the broken lines and curves.

When the thermistor 41 is not electrified, the resistance value of the thermistor 41 is a normal resistance value, which corresponds to the temperature of the thermistor 41, or, in other words, the temperature Tt in the collected-liquid tank 35. Therefore, as illustrated in FIG. 4, after electrification of the thermistor 41 is started at the zeroth timing t0, the thermistor voltage Vs increases rapidly to an initial voltage Vi, which is the voltage value corresponding to the normal resistance value.

As has been described, the thermistor 41 is the NTC thermistor and thus exhibits a lower resistance value at a higher temperature. Therefore, as the temperature Tt in the collected-liquid tank 35, which is the ambient temperature of the thermistor 41, becomes higher, the normal resistance value becomes smaller. That is, as the temperature Tt in the collected-liquid tank 35 becomes higher, the timing at which the thermistor voltage Vs reaches the initial voltage Vi becomes earlier.

Also, as the thermistor 41 is continuously electrified, the temperature of the thermistor 41 increases and thus the resistance value of the thermistor 41 decreases correspondingly. Therefore, after the thermistor voltage Vs reaches the initial voltage Vi, the thermistor voltage Vs gradually decreases as the temperature of the thermistor 41 increases.

The heat dissipation manner of the thermistor 41 when the thermistor 41 is not immersed in the oil is different from the heat dissipation manner of the thermistor 41 when the thermistor 41 is immersed in the oil. Therefore, even in the circumstance in which the temperature of the oil is equal to the temperature of the CNG, the temperature increasing speed of the thermistor 41 when the thermistor 41 is not immersed in the oil is different from the temperature increasing speed of the thermistor 41 when the thermistor 41 is immersed in the oil.

That is, when the pressure of the CNG in the collected-liquid tank 35 is comparatively high, the heat dissipation amount of the thermistor 41 with respect to the CNG tends to be greater than the heat dissipation amount of the thermistor 41 with respect to the oil if the conditions such as the temperature of the CNG and the temperature of the oil are constant. The temperature increasing speed of the thermistor 41 when the thermistor 41 is not immersed in the oil is thus lower than the temperature increasing speed of the thermistor 41 when the thermistor 41 is immersed in the oil. As a result, as shown in FIG. 4, after the thermistor voltage Vs reaches the initial voltage Vi, the decreasing speed of the thermistor voltage Vs when the thermistor 41 is not immersed in the oil is lower than the decreasing speed of the thermistor voltage Vs when the thermistor 41 is immersed in the oil.

The oil retaining amount determination device of the present embodiment performs a determination procedure by which the thermistor 41 is electrified and a determination is made as to whether the thermistor 41 is immersed in the oil based on the decreasing manner of the thermistor voltage Vs when the thermistor 41 is electrified. Specifically, the oil retaining amount determination device obtains a first voltage V1, which is the thermistor voltage Vs at the first timing t1, when the thermistor voltage Vs decreases after having reached the initial voltage Vi. The oil retaining amount determination device also obtains a second voltage V2, which is the thermistor voltage Vs at the second timing t2, later than the timing t1. The oil retaining amount determination device then calculates a voltage difference ΔV, which is the difference between the first voltage V1 and the second voltage V2. If the voltage difference ΔV is greater than or equal to a reference voltage difference ΔVth, the oil retaining amount determination device determines that the thermistor 41 is immersed in the oil. In contrast, if the voltage difference ΔV is smaller than the reference voltage difference ΔVth, the oil retaining amount determination device determines that the thermistor 41 is not immersed in the oil. The reference voltage difference ΔVth is a reference value with reference to which it is determined whether the thermistor 41 is immersed in the oil based on the decreasing speed of the thermistor voltage Vs. It is preferable to determine the reference voltage difference ΔVth in advance using a test or simulation.

Hereinafter, the period from the zeroth timing t0, at which electrification of the thermistor 41 is started, to the first timing t1 will be referred to as “the first period P1”. The period from the first timing t1 to the second timing t2 will be referred to as “the second period P2”. The first timing t1 in the first period P1 is set at a timing that is later than the timing at which the thermistor voltage Vs reaches the initial voltage Vi and at which the difference between the first voltage V1 and the initial voltage Vi becomes maximally small, regardless of the temperature Tt in the collected-liquid tank 35.

When the CNG flows in the high-pressure fuel pipe 22, as in the case of engine operation using CNG, the speed of the temperature increase of the thermistor 41, which is caused by the heat generated by the thermistor 41, changes in correspondence with the flow amount of the CNG. For example, even if the temperature of the CNG flowing into the collected-liquid tank 35 is constant, the temperature of the thermistor 41 tends to increase slowly when the flow amount of the CNG is great, compared to when the flow amount of the CNG is small. Therefore, if the above-described determination procedure is executed in the circumstance in which the CNG flows into the collected-liquid tank 35, the aforementioned voltage difference ΔV varies in correspondence with the flow amount of the CNG flowing into the collected-liquid tank 35. This lowers accuracy of the determination as to whether the thermistor 41 is immersed in the oil. To solve this problem, the oil retaining amount determination device of the present embodiment performs the determination procedure when the condition that flow of the CNG in the high-pressure fuel pipe 22 (the collected-liquid tank 35) is stopped is satisfied.

Also, when the vehicle travels, the heat generated by the internal combustion engine 11 is transmitted to the collected-liquid tank 35 and may increase the temperature difference between the CNG and the oil in the collected-liquid tank 35. As the temperature difference between the CNG and the oil in the collected-liquid tank 35 becomes greater, the determination accuracy of the determination procedure tends to become lower. Further, when the vehicle travels, the level of the oil in the collected-liquid tank 35 may vary. If this is the case, the thermistor 41 may be immersed in or exposed from the oil when the determination procedure is in execution. Also in these cases, the determination accuracy of the determination procedure is not high. It is thus preferable to execute the determination procedure when the vehicle is stopped. For this purpose, the oil retaining amount determination device of the present embodiment executes the determination procedure when the engine 11 is starting. The vehicle is highly likely to be in a stopped state when the engine 11 is starting. Therefore, lowering of the determination accuracy of the determination procedure is restrained by performing the determination procedure when the engine 11 is starting.

Further, for certain values of the temperature Tt in the collected-liquid tank 35, the decreasing manner of the thermistor voltage Vs after the thermistor voltage Vs reaches the initial voltage Vi may be substantially unchanged from the case in which the thermistor 41 is immersed in the oil to the case in which the thermistor 41 is not immersed in the oil.

Therefore, the oil retaining amount determination device of the present embodiment sets, in advance, a specific temperature range in which the determination accuracy of the determination procedure is maintained without being lowered. The oil retaining amount determination device performs the determination procedure when the condition that the temperature Tt in the collected-liquid tank 35 is in the specific temperature range is satisfied. That is, if the temperature Tt in the collected-liquid tank 35 is either higher than the upper limit of the specific temperature range or lower than the lower limit of the specific temperature range, the determination accuracy of the determination procedure tends to be lowered. In these cases, the oil retaining amount determination device does not execute the determination procedure.

There is a certain level of correlation between the initial voltage Vi at the time of electrification of the thermistor 41 and the temperature Tt in the collected-liquid tank 35. Therefore, the oil retaining amount determination device of the present embodiment estimates the temperature Tt in the collected-liquid tank 35 based on the thermistor voltage Vs at the first timing t1, which is after the electrification of the thermistor 41 is started. If the estimated temperature in the collected-liquid tank 35 is in the specific temperature range, the oil retaining amount determination device performs the determination procedure. If the estimated temperature in the collected-liquid tank 35 is outside the specific temperature range, the oil retaining amount determination device does not carry out the determination procedure.

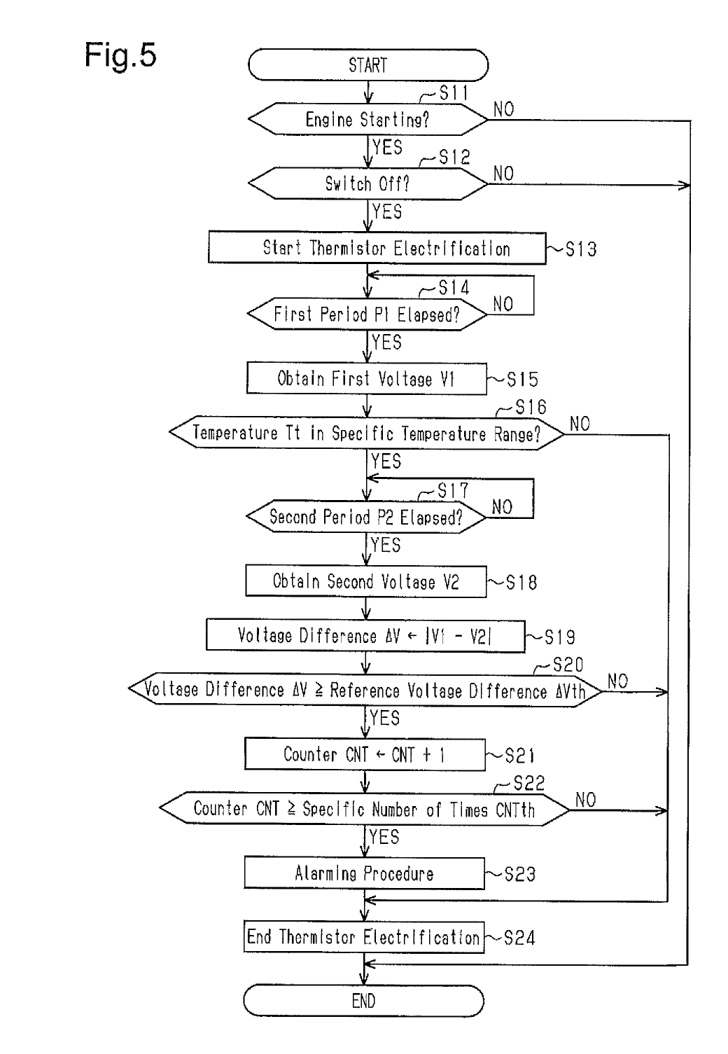

With reference to the flowchart of FIG. 5, a procedure routine performed by the control unit 25 to determine whether the oil retaining amount of the collected-liquid tank 35 is greater than or equal to the specific amount will hereafter be described. The procedure routine is performed by predetermined control cycles.

Referring to FIG. 5, the control unit 25 determines whether the ignition switch of the vehicle has been turned on and the engine is starting (Step S11). A determination that the engine is starting may be made if, for example, the starter motor is in actuation or a predetermined time has not yet elapsed since activation of the ignition switch.

If the engine is not starting (Step S11: NO), the control unit 25 suspends the procedure routine. In contrast, if the engine is starting (Step S11: YES), the control unit 25 determines whether the switch 27 is off (Step S12).

When the switch 27 is on, it is likely that engine operation using CNG has already started and the CNG flows in the high-pressure fuel pipe 22. In contrast, when the switch 27 is off, the engine operation using CNG has not yet started and the CNG does not flow in the high-pressure fuel pipe 22. Therefore, if the switch 27 is on (Step S12: NO), the control unit 25 suspends the procedure routine. That is, the determination procedure for determining whether the thermistor 41 is immersed in the oil in the collected-liquid tank 35 is not performed.

In contrast, when the switch 27 is off (Step S12: YES), the control unit 25 starts electrification of the thermistor

(Step S13). The control unit 25 then determines whether the first period P1 has elapsed since the electrification of the thermistor 41 was started (Step S14). If the first period P1 has not yet elapsed (Step S14: NO), the control unit 25 repeats the procedure of Step S14. In contrast, if the first period P1 has already elapsed (Step S14: YES), the control unit 25 obtains the thermistor voltage Vs at the corresponding time point and sets the obtained thermistor voltage Vs as the first voltage V1 (Step S15). The first voltage V1 corresponds to the thermistor voltage Vs at the first timing t1.

Subsequently, the control unit 25 estimates the temperature Tt in the collected-liquid tank 35 based on the first voltage V1. The control unit 25 then determines whether the estimated temperature Tt is in the specific temperature range (Step S16). When the temperature Tt is outside the specific temperature range (Step S16: NO), the control unit 25 carries out Step S24, the procedure of which will be later described.

In contrast, when the temperature Tt is in the specific temperature range (Step S16: YES), the control unit 25 determines whether the second period P2 has elapsed since the first voltage V1 was obtained (Step S17). If the second period P2 has not yet elapsed (Step S17: NO), the control unit 25 repeats the procedure of Step S17. If the second period P2 has already elapsed (Step S17: YES), the control unit 25 obtains the thermistor voltage Vs at the corresponding time point and sets the obtained thermistor voltage Vs as the second voltage V2 (Step S18). The second voltage V2 corresponds to the thermistor voltage Vs at the second timing t2.

The control unit 25 calculates the voltage difference ΔV, which is the difference between the first voltage V1 and the second voltage V2 (Step S19). The control unit 25 then determines whether the calculated voltage difference ΔV is greater than or equal to the reference voltage difference ΔVth (Step S20). If the voltage difference ΔV is greater than or equal to the reference voltage difference ΔVth, the control unit 25 determines that the thermistor 41 is likely to be immersed in the oil. In contrast, when the voltage difference ΔV is smaller than the reference voltage difference ΔVth, the control unit 25 determines that the thermistor 41 is not immersed in the oil. Therefore, if the voltage difference ΔV is smaller than the reference voltage difference Δth (Step S20: NO), the control unit 25 carries out Step 24, the procedure of which will be described later.

In contrast, when the voltage difference ΔV is greater than or equal to the reference voltage difference ΔVth (Step S20: YES), the control unit 25 increments a counter CNT by “1” (Step S21). The counter CNT is a variable for counting the number of times by which a determination that the thermistor 41 is likely to be immersed in the oil is made.

Then, the control unit 25 determines whether the counter CNT is greater than or equal to a specific number of times CNTth (Step S22). The specific number of times CNTth is a value in accordance with which an alarming procedure, which will be described later, is performed when the oil retaining amount of the collected-liquid tank 35 is highly likely to be greater than or equal to the specific amount. The specific number of times CNTth is set, in advance, to a value greater than or equal to “2” (for example, 3). If the updated counter CNT is smaller than the specific number of times CNTth (Step S22: NO), the control unit 25 performs Step 24, the procedure of which will be described later. In contrast, when the counter CNT is greater than or equal to the specific number of times CNTth (Step S22: YES), the control unit 25 executes the alarming procedure by which the alarm lamp 26 is illuminated (Step S23). This informs an occupant (occupants) of the vehicle of the fact that the oil retaining amount of the collected-liquid tank 35 is greater than or equal to the specific amount. The control unit 25 then carries out Step S24, which is the subsequent step.

In Step S24, the control unit 25 ends the electrification of the thermistor 41. The control unit 25 then suspends the procedure routine. The procedure of Step S24 may be performed prior to execution of the alarming procedure as long as the second voltage V2 has been obtained.

Operation of the oil retaining amount determination device of the present embodiment will now be described.

When the internal combustion engine 11 is starting (Step S11: YES), the gasoline, not the CNG, is supplied to the combustion chamber 16. Therefore, when the switch 27 is off (Step S12: YES), flow of the CNG in the high-pressure fuel pipe 22 is stopped. As a result, the determination procedure is performed.

In the determination procedure, electrification of the thermistor 41 is started (Step S13) and the voltage difference ΔV, which corresponds to the difference between the first voltage V1 at the first timing t1 and the second voltage V2 at the second timing t2, is calculated (Steps S14 to S19). If the voltage difference ΔV is greater than or equal to the reference voltage difference ΔVth (Step S20: YES), a determination that the thermistor 41 is likely to be immersed in the oil is made and the counter CNT is incremented by “1” (Step S21). In contrast, when the voltage difference ΔV is smaller than the reference voltage difference ΔVth (Step S20: NO), a determination that the thermistor 41 is not immersed in the oil is made and the counter CNT is not incremented.

If the voltage difference ΔV is greater than or equal to the reference voltage difference ΔVth, the counter CNT is updated. When, eventually, the counter CNT is greater than or equal to the specific number of times CNTth (Step S22: YES), the alarm lamp, which is arranged in the vehicle, is illuminated (Step S23). This allows an occupant (occupants) of the vehicle to realize that the oil retaining amount of the collected-liquid tank 35 is greater than or equal to the specific amount and the oil must be discharged from the collected-liquid tank 35. If this alarming procedure is started, the electrification of the thermistor 41 is ended (Step S24).

If the temperature Tt in the collected-liquid tank 35 estimated based on the first voltage V1, which is obtained at the first timing t1, is outside the specific temperature range (Step S16: NO), the electrification of the thermistor 41 is ended (Step S24). In this case, determination whether the thermistor 41 is immersed in the oil is not carried out.

The above-described configuration and operation have the advantages described below.

(1) The oil retaining amount determination device performs the determination procedure to determine whether the thermistor 41 is immersed in the oil based on change of the thermistor voltage Vs after electrification of the thermistor 41 is started. The determination procedure is carried out in the circumstance in which flow of the CNG in the high-pressure fuel pipe 22 is stopped, or, in other words, the CNG does not flow in the collected-liquid tank 35.

It is thus unnecessary to take variation in the flow amount of the CNG in the high-pressure fuel pipe 22 into consideration. As a result, even if the oil retaining amount determination device of the present embodiment is employed in various types of internal combustion engines 11 exhibiting different displacements, a step of adapting reference values does not have to be added. This facilitates determination whether the oil retaining amount of the collected-liquid tank 35 is greater than or equal to the specific amount.

(2) In the environment in which the oil retaining amount determination device is used, the heat dissipation amount of the thermistor 41 with respect to the CNG tends to be greater than the heat dissipation amount of the thermistor 41 with respect to the oil. Therefore, in the determination procedure, when the voltage difference ΔV, which is the difference between the thermistor voltage Vs at the first timing t1 (the first voltage V1) and the thermistor voltage Vs at the second timing t2 (the second voltage V2), is greater than or equal to the reference voltage difference ΔVth, a determination that the thermistor 41 is immersed in the oil is made.

(3) The collected-liquid tank 35 is arranged downstream from the pressure reducing valve 33. Therefore, when the CNG does not flow in the collected-liquid tank 35, the pressure in the collected-liquid tank 35 is substantially constant. This restrains variation in the determination accuracy of the determination procedure caused by variation in the pressure in the collected-liquid tank 35.

(4) When the temperature Tt in the collected-liquid tank 35 is outside the specific temperature range, the determination accuracy of the determination procedure may be low. Therefore, the determination procedure is not performed. This restrains lowering of the determination accuracy of the determination procedure.

(5) The determination procedure is performed in the engine operation using gasoline. The determination procedure is thus executed in a state in which the flow of CNG in the high-pressure fuel pipe 22 is stopped. This makes it unnecessary to stop the engine operation to perform the determination procedure.

(6) The determination accuracy of the determination procedure may be lowered by influence caused when the vehicle travels. In the present embodiment, the determination procedure is performed at the time of engine starting, in which the vehicle is highly likely to be in a stopped state. The determination procedure is thus executed while avoiding influence caused when the vehicle travels. This restrains lowering of the determination accuracy of the determination procedure.

(7) After the determination procedure is ended, the electrification of the thermistor 41 is ended immediately. This decreases unnecessary electrification of the thermistor 41, thus restraining change of the performance of the thermistor 41 as the time elapses.

(8) The oil retaining amount determination device counts the number of times by which a determination that the thermistor 41 is immersed in the oil is made by the determination procedure. Also, the oil retaining amount determination device performs the alarming procedure when the aforementioned number of times is greater than or equal to the specific number of times CNTth. This restrains erroneous illumination of the alarm lamp 26 when the oil retaining amount of the collected-liquid tank 35 is actually smaller than the specific amount.

The illustrated embodiment may be modified to the forms described below.

When the pressure in the collected-liquid tank 35 is comparatively low, the heat dissipation amount of the thermistor 41 with respect to the CNG tends to be smaller than the heat dissipation amount of the thermistor 41 with respect to the oil if conditions such as the temperature of the CNG and the temperature of the oil are constant. That is, if the thermistor 41 is electrified when the pressure in the collected-liquid tank 35 is comparatively low, the decreasing speed of the thermistor voltage Vs tends to be high when the thermistor 41 is not immersed in the oil compared to when the thermistor 41 is immersed in the oil. In these circumstances, it is preferable to determine that the thermistor 41 is immersed in the oil if the voltage difference ΔV, which is the difference between the first voltage V1, or the thermistor voltage Vs at the first timing t1, and the second voltage V2, or the thermistor voltage Vs at the second timing t2, is smaller than or equal to a reference voltage difference ΔVth2.

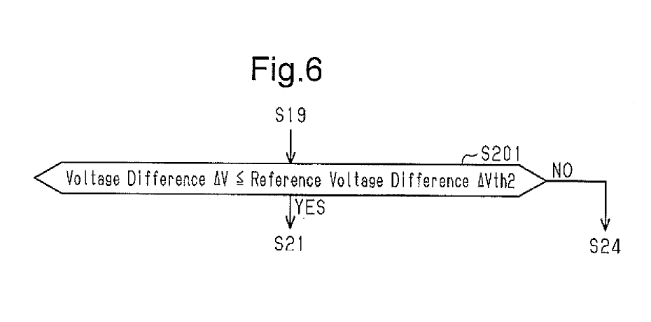

That is, referring to FIG. 6, the control unit 25 determines whether the voltage difference ΔV, which is calculated in Step S19, is smaller than or equal to the reference voltage difference ΔVth2 (Step S201). If the voltage difference ΔV is greater than the reference voltage difference zWth2 (Step S201: NO), the control unit 25 performs the procedure of Step S24 to end electrification of the thermistor 41. In contrast, when the voltage difference ΔV is smaller than or equal to the reference voltage difference ΔVth2 (Step S201: YES), the control unit 25 performs the procedure of Step S21 to increment the counter CNT by “1”. The reference voltage difference ΔVth2 is a reference value with reference to which it is determined whether the alarming procedure should be carried out and may be determined as needed. In this configuration, a determination that the thermistor 41 is immersed in the oil is made when the voltage difference ΔV is smaller than or equal to the reference voltage difference ΔVth2 in the environment in which the heat dissipation amount of the thermistor 41 with respect to the CNG tends to be smaller than the heat dissipation amount of the thermistor 41 with respect to the oil.

If an electric current flowing in the thermistor 41 is defined as a thermistor electric current (a resistance electric current), determination whether the thermistor 41 is immersed in the oil may be performed based on change of the thermistor electric current when the thermistor 41 is electrified. In this case, the thermistor electric current corresponds to a characteristic caused by change of the resistance value of the thermistor 41. For example, in the illustrated embodiment, the thermistor electric current becomes smaller as the resistance value of the thermistor 41 becomes greater. As a result, the thermistor electric current increases as the temperature of the thermistor 41 increases and the resistance value of the thermistor 41 decreases. Further, when the pressure of the CNG in the collected-liquid tank 35 is a specific pressure that is greater than the atmospheric pressure as in the case of the illustrated embodiment, the temperature increasing speed of the thermistor 41 is low when the thermistor 41 is not immersed in the oil compared to when the thermistor 41 is immersed in the oil. The increasing speed of the thermistor electric current thus becomes low when the thermistor 41 is not immersed in the oil compared to when the thermistor 41 is immersed in the oil.

Therefore, a determination that the thermistor 41 is immersed in the oil may be made if, after electrification of the thermistor 41 is started, an electric current difference, which is the difference between the thermistor electric current at the first timing at which the thermistor electric current increases and the thermistor electric current at the second timing, which is later than the first timing, is greater than or equal to a reference electric current difference. Like the reference voltage difference ΔVth, the reference electric current difference is a reference value with reference to which it is determined whether the thermistor 41 is immersed in the oil based on the increasing speed of the thermistor electric current.

When the engine is stopped, CNG does not flow in the high-pressure fuel pipe 22. Therefore, the determination procedure may be performed when the engine is stopped.

If the determination procedure is carried out in engine operation using gasoline in the circumstance in which CNG does not flow in the high-pressure fuel pipe 22, the determination procedure may be performed after completion of engine starting. For example, when the transmission of the vehicle is in the parking range or braking force is applied to the vehicle through parking brake, the vehicle is highly likely to be in a stopped state. In this case, the determination procedure may be performed in engine operation using gasoline after engine starting.

If the determination procedure is carried out in engine operation using gasoline in the circumstance in which CNG does not flow in the high-pressure fuel pipe 22, the determination procedure may be performed when the vehicle travels through the engine operation using gasoline.

In the illustrated embodiment, it is determined whether the CNG flows in the high-pressure fuel pipe 22 depending on whether the switch 27 is off. However, such determination may be carried out using any other method. For example, a flow amount sensor for detecting the flow amount of CNG may be arranged in the high-pressure fuel pipe 22. Based on a detection result of the flow amount sensor, it may be determined whether the CNG flows in the high-pressure fuel pipe 22.

Estimation of the temperature Tt in the collected-liquid tank 35 does not necessarily have to be based on the thermistor voltage Vs at the first timing t1. For example, such estimation may be carried out based on the thermistor voltage Vs at any other timing. Alternatively, a temperature sensor may be arranged in the collected-liquid tank 35 and the temperature Tt in the collected-liquid tank 35 may be obtained based on a detection result of the temperature sensor.

In the circumstance in which the coolant circulating in the internal combustion engine 11 is not yet sufficiently cooled after completion of a previous cycle of engine operation, the ignition switch may be turned on to re-start the engine. In this case, the heat that has been generated by the engine 11 in the previous cycle of engine operation maintains the collected-liquid tank 35 in a heated state. Therefore, there may be a great difference between the temperature of the CNG and the temperature of the oil in the collected-liquid tank 35. The above-described determination procedure is performed on the presumption that the temperature difference between the CNG and the oil is small. Accordingly, if the determination procedure is carried out in this circumstance, the determination accuracy tends to be varied. Specifically, if the time that has elapsed since completion of the previous cycle of engine operation is less than a specific time, it is likely that there is a great difference between the temperature of the CNG and the temperature of the oil in the collected-liquid tank 35. Therefore, the determination procedure may be avoided for the corresponding cycle of engine starting.

Further, even if the time that has elapsed since completion of the previous cycle of engine operation is less than the specific time, the temperature of the coolant may be lower than a specific temperature. In this case, it may be determined that the difference between the temperature of the CNG and the temperature of the oil in the collected-liquid tank 35 is small. Therefore, the determination procedure may be performed for the corresponding cycle of engine starting.

The specific number of times CNTth may be “1”. In this case, although there is a possibility of erroneous determination, the advantages similar to the advantages (1) and (2) of the illustrated embodiment are ensured. Alternatively, the specific number of times CNTth may be “4” or greater.

In the illustrated embodiment, it is determined whether the thermistor 41 is immersed in the oil based on the voltage difference ΔV between the first voltage V1 at the first timing t1 and the second voltage V2 at the second timing t2. However, such determination may be performed using any other method. For example, with reference to FIG. 4, the thermistor voltage Vs (the second voltage V2) when the thermistor 41 is not immersed in the oil is greater than the thermistor voltage Vs (the second voltage V2) when the thermistor 41 is immersed in the oil. Therefore, if the second voltage V2 at the second timing t2 is greater than or equal to the reference voltage, a determination that the thermistor 41 is not immersed in the oil may be made. If the second voltage V2 is smaller than the reference voltage, a determination that the thermistor 41 is immersed in the oil may be made. This also ensures the advantage similar to the advantage (1) of the illustrated embodiment.

However, as has been described, if an NTC thermistor is employed as the thermistor 41, the thermistor voltage Vs becomes smaller as the temperature of the thermistor 41 becomes higher. It is thus preferable that the aforementioned reference voltage be set to a smaller value for a higher temperature of the thermistor 41 (≈the temperature Tt in the collected-liquid tank 35) before the start of electrification of the thermistor 41.

The thermistor 41 does not necessarily have to be the NTC thermistor as long as the thermistor generates heat by being electrified. For example, a PTC thermistor (a Positive Temperature Coefficient Thermistor) may be employed as the thermistor 41. Further, the resistor may be any other resistor than a thermistor as long as the resistor generates heat by being electrified.

As long as the separating portion is capable of separating oil from CNG, the separating portion may have any other configuration than the configuration of the element 36. For example, the separating portion may be configured to separate oil from CNG by rotating a rotary fan.

The internal combustion engine 11 may be a mono-fuel type internal combustion engine operated only by CNG. In this case, it is preferable that the determination procedure be carried out at a timing at which the engine is stopped, as has been described.

A collected-liquid tank may be arranged in a supply line in which any other gas fuel than CNG (for example, hydrogen gas) flows and a determination may be made as to whether the oil retaining amount of the collected-liquid tank is greater than or equal to a specific amount.

1. An oil retaining amount determination device having a tank arranged in a supply line of a gas fuel and a separating portion arranged in the tank to separate oil from the gas fuel that flows into the tank, the oil retaining determination device determining whether an oil retaining amount of the tank is greater than or equal to a specific amount, wherein
the oil retaining determination device comprises:
a resistor located in a downward direction from the separating portion in the tank, the resistor generating heat by being electrified; and
a control unit for electrifying the resistor, the control unit executing a determination procedure to determine whether the resistor is immersed in the oil based on change of a characteristic caused in correspondence with change of a resistance value of the resistor when the resistor is electrified, and
the control unit executes the determination procedure when flow of the gas fuel in the supply line is stopped.

2. The device according to claim 1, wherein, if a voltage applied to the resistor is defined as a resistance voltage, the control unit determines whether the resistor is immersed in the oil based on change of the resistance voltage when the resistor is electrified.

3. The device according to claim 2, wherein, after electrification of the resistor is started, the control unit determines that the resistor is immersed in the oil when a voltage difference that is the difference between the resistance voltage at a first timing at which the resistance voltage decreases and the resistance voltage at a second timing later than the first timing is greater than or equal to a reference voltage difference.

4. The device according to claim 2, wherein, after electrification of the resistor is started, the control unit determines that the resistor is immersed in the oil when a voltage difference that is the difference between the resistance voltage at a first timing at which the resistance voltage decreases and the resistance voltage at a second timing later than the first timing is smaller than or equal to a reference voltage difference.

5. The device according to claim 1, wherein the control unit does not execute the determination procedure when the temperature in the tank is outside a specific temperature range.

6. The device according to claim 1, wherein
the gas fuel is supplied into a combustion chamber of an internal combustion engine after having flowed in the supply line,
the engine is switchable selectively between operation using the gas fuel and operation using a different fuel other than the gas fuel, and
the control unit executes the determination procedure when the engine is operated using the other fuel.

7. The device according to claim 6, wherein
the engine is an internal combustion engine in which the other fuel is supplied into the combustion chamber to start the engine, and
the control unit executes the determination procedure when the engine is starting.

8. The device according to claim 1, wherein the control unit ends electrification of the resistor after ending execution of the determination procedure.

9. The device according to claim 1, wherein
the control unit counts the number of times by which a determination that the resistor is immersed in the oil is made through execution of the determination procedure, and
if the number of times is greater than or equal to a specific number of times that is greater than “2”, the control unit informs that the oil retaining amount of the tank is greater than or equal to the specific amount.

10. The device according to claim 1, further comprising a pressure reducing valve for reducing the pressure of the gas fuel, wherein the oil retaining amount determination device is configured such that the gas fuel flows into the tank after the pressure of the gas fuel is reduced by the pressure reducing valve.
